(19) United States
(12) Patent Application Publication
(10) Pub. No.: US 2008/0211237 A1
(43) Pub. Date: Sep. 4, 2008

(54) ELECTRICAL POWER SUPPLY FOR AN AIRCRAFT

(75) Inventor: Serge BERENGER, Chevilly Larue (FR)

Correspondence Address: OBLON, SPIVAK, MCCLELLAND MAIER & NEUSTADT, P.C., 1940 DUKE STREET, ALEXANDRIA, VA, 22314, US

(73) Assignee: HISPANO SUIZA

(21) Appl. No.: 11/944,565

(22) Filed: Nov. 23, 2007

(30) Foreign Application Priority Data
Nov. 23, 2006 (FR) 0655072

(51) Int. Cl. H02P 9/00; H02J 3/38

(52) U.S. Cl. 290/40 B; 322/28; 307/9.1

(57) ABSTRACT

A main generator delivers an AC voltage to an electricity network on board an aircraft via a main line having at least one line contactor mounted therein, the voltage being regulated by a regulator. An engine electricity network delivers electricity to various loads situated in the zone of an engine fitted to the aircraft and to an engine control computer, the engine electricity network having a first fed input connected to the main electricity power supply line via a secondary electricity power supply line, upstream from the line contactor in order to receive directly electricity derived from the main generator without transiting via the electricity network on board the aircraft. The voltage regulator regulating the voltage delivered by the main generator may be situated in the engine zone and is powered by the engine electricity network.

### BACKGROUND OF THE INVENTION

The invention relates to electrically powering aircraft and the engines fitted thereto.

The field of application of the invention is more particularly that of airplanes fitted with gas turbine engines. Nevertheless, the invention is also applicable to airplanes fitted with other types of engine and more generally to various types of aircraft, i.e. both airplanes and helicopters.

In an airplane, electricity is commonly generated by a main generator that is generally integrated in a starter/generator unit and that delivers an alternating voltage fed to an electricity network of the airplane via at least one line contactor. The airplane electricity network distributes electricity in the form of alternating current (AC) or direct current (DC) as needed for operating electrical loads situated in the fuselage zone and also in the engine zone.

The AC voltage delivered by the main generator is regulated by a voltage regulator situated in the fuselage zone. The voltage regulator controls current delivered to an exciter that is coupled to the main generator so as to maintain the AC voltage delivered by the main generator in a determined range. For this purpose, the voltage regulator is itself powered with electricity from the airplane electricity network or from an auxiliary generator such as a permanent magnet generator mounted on a shaft in common with the main generator and the exciter.

A computer controlling the engine and known as a full authority digital engine control (FADEC) is situated in the engine zone and serves to control the operation of the engine. After the engine starting stage, during which the FADEC is powered from the airplane electricity network, the FADEC is powered electrically by a particular generator that is coupled mechanically to the engine.

For redundancy purposes, in order to mitigate the consequences of failure of any of the elements of the electricity power supply system, these elements are usually redundant.

FIG. 1 is a diagram showing one such known architecture for an electricity power supply system as typically used in an airplane fitted with gas turbine engines.

In FIG. 1, dashed line 100 represents an engine zone boundary, while dashed line 200 represents a boundary of an airplane fuselage zone. The term “engine zone” is used herein to mean the engine and its surroundings, and in particular a perimeter including specifically the engine proper, an accessory gearbox (AGB) coupled to a turbine shaft of the engine, accessories mounted on the gearbox, the engine pod that includes equipment for reversing thrust, and the pylori connecting the pod to the wing.

In the engine zone, there can be found a starter/generator (S/G) 110 comprising a main electricity generator 112 constituting a synchronous generator, an exciter 114 with a secondary magnetic circuit that powers the rotor of the main generator via a rotary diode rectifier bridge 116, and an auxiliary generator 118 such as a permanent magnet generator. The rotors of the main generator 112, of the exciter 114, and of the auxiliary generator 118 are mounted in common on a shaft that is coupled to the transmission gearbox (not shown) of the engine.

The main generator delivers an AC voltage that is conveyed to the airplane electricity network 210 or primary on-board electricity network, in the fuselage zone, via a line or harness 120. The network on board the airplane constitutes the source for distributing electricity to electrical loads, whether activated continuously or transiently, whether in the fuselage zone or in the engine zone. Electrical loads are commonly activated in transient manner in the engine zone by controlling power contactors of the network on board the airplane.

The engine zone also contains a FADEC 130 that is powered electrically by a specific generator 140 such as a permanent magnet alternator having its rotor coupled to the engine transmission gearbox. The AC voltage delivered by the generator 140 is rectified and raised to a required level by an AC/DC converter 132 so as to power the components 134 of the FADEC 130. It should be observed that the FADEC 130 is also connected via a line or harness 136 to a DC bus 216 or the airplane electricity network in the fuselage zone in order to be powered while the engine is being started.

A line contactor 212 is inserted at the input to the airplane electricity network between the line 120 and an AC bus 214 of the network. The electricity available on the bus 214 powers various loads directly or else via voltage converters, in particular an AC/DC converter (not shown) that powers the DC bus 216.

While the engine is in operation, the starter/generator 110 operates in synchronous generator mode. The voltage delivered by the main generator 112 is regulated at the input to the network 210 on board the aircraft by means of a voltage regulator 220 situated in the fuselage zone. The voltage regulator receives information representative of the voltage on the power supply line 120 at a point of regulation (POR) 211 situated in the fuselage zone at the input to the on-board network 210, immediately upstream from the line contactor 212. The voltage regulator 220 delivers DC to the stator (primary magnetic circuit) of the exciter 114 via a power supply line or harness 222, and the AC recovered from the rotor (secondary magnetic circuit) of the exciter is rectified by the rotary diode bridge 116 to power the rotor (primary magnetic circuit) of the main generator 112. The electricity delivered to the exciter 114 by the voltage regulator 220 is adjusted so as to maintain the value of the AC voltage at the POR point 211 within a predetermined range of values. The voltage regulator 220 is powered with AC by the auxiliary generator 118 via a power supply line or harness 224. The AC is rectified by a rectifier and delivered to a DC/DC converter that is controlled to deliver the current required by the exciter.

In starting mode, the voltage regulator 220 is powered from the DC bus 216 (or from some other source) so as to enable it to operate and deliver an AC voltage to the primary magnetic circuit of the exciter 114. Simultaneously, with the line contactor 212 closed, the stator (secondary magnetic circuit) of the main generator is powered with AC by the power supply line 120 from the AC bus 214 (or from some other source), the generator then operating as a synchronous electric motor. The airplane engine is then rotated via its transmission gearbox. After the airplane engine has started, the line contactor 212 is opened so as to be subsequently closed when the voltage level at the point of regulation has reached a predetermined minimum value.

A control and protection circuit 230, which may be integrated in the voltage regulator, operates the line contactor 212 during starting, and also in the event of an electricity fault being detected. The control and protection circuit 230 receives for this purpose in particular information representative of the current I_{L} on the power supply line 120.

As shown in FIG. 1, the following are also provided by way of redundancy:
a second starter/generator 110′ similar to the starter/generator 110 with a main generator 112′, an exciter 114′, a rotary diode bridge 116′, and an auxiliary generator 118′;
a second line contactor 212′ at the input to the network 210 on board the airplane, between a power supply line or harness 120′ that powers the airplane electricity network with the AC delivered by the main generator 112′, and an AC bus 214′ of the network 210 on board the airplane;
a second voltage regulator 220′ similar to the regulator 220 and powered by the auxiliary line 118′ via a power supply line or harness 224′ and regulating the voltage at a point of regulation POR′ 211′ at the input to the network 210 on board the airplane, upstream from the line contactor 212′, the voltage regulator 220′ delivering electricity to the exciter 114′ via a line or harness 222′ suitable for maintaining the voltage at the point POR′ 211′ within a predetermined range;
a second control and protection circuit 230′ similar to the circuit 230 and possibly integrated in the voltage regulator 2201, for controlling the line contactor 212′; and
a specific generator 140′ for powering the FADEC 130 with electricity, similar to the generator 140.

A line contactor 232 is interposed between the AC buses 224 and 2241. The contactor 232 is normally open. It is closed under the control of a logic circuit for protecting and configuring primary distribution of electricity in the network 210 on board the airplane when one of the main generators 112, 112′ can no longer deliver the desired voltage on the corresponding bus 214, 214′.

It should be observed that the AC/DC converter of the FADEC 130 is also duplicated, for redundancy purposes so as to have two converters 132, 132′ powered by the specific generators 140, 140′ so as to provide electricity to the components 134 of the FADEC.

A well-known architecture for an electricity power supply system of the kind described above has been found to be effective, but drawbacks arise when, as is the present trend, electricity is used instead of hydraulic power for actuating various pieces of equipment in the engine and its surroundings. Conveying electricity from the network on board the airplane to loads external to the fuselage by means of electricity lines or harnesses that must be carefully secured and isolated leads to a large amount of weight and bulk that can become prohibitive when the number of pieces of electrical equipment for powering increases.

To overcome that difficulty, proposals are made in patent application WO 2006/087379 in the name of the present Applicant, to integrate an electricity distribution bus in the engine zone for the various pieces of electrical equipment associated with the engine and its surroundings. The buses forming the distribution network in the engine zone are powered from the electricity network on board the airplane, thus making it possible to limit the number of electrical connections between the engine zone and the network on board the airplane.

Proposals are also made in patent application EP 1852953 in the name of the present Applicant to integrate an electricity distribution network in the engine zone having at least one electricity distribution bus for electrical equipment of the engine and its surroundings, and an electricity power supply circuit. The electricity power supply circuit has one input connected to the electricity network on board the airplane for receiving a voltage delivered by the on-board network, and another input receiving a voltage delivered by an electricity generator driven by the airplane engine, with the electricity power supply circuit delivering to the electricity distribution bus in the engine zone a voltage taken from the voltage it receives on one of its inputs or on the other of its inputs, depending on requirements. A secure electricity availability node is thus integrated in the engine zone for powering electrical loads integrated in the engine or its surroundings, and only one connection with the electricity network on board the airplane then sufficing to ensure that electricity is available on the engine electricity network when the specific electricity generator (which might be duplicated for redundancy purposes) does not suffice to cover requirements.

### OBJECT AND SUMMARY OF THE INVENTION

An object of the invention is to provide an optimized architecture for an electricity power supply system for an aircraft enabling an engine zone of the aircraft to have sufficient electricity available for powering electrical loads integrated in the engine and in its surroundings, without being penalizing in terms of weight and bulk.

This object is achieved by a system comprising at least one main generator for delivering AC, an electricity network on board the aircraft, a main electricity power supply connecting the main generator to the electricity network on board the aircraft to power the electricity network on board the aircraft to feed it with AC delivered by the main generator, at least one line contactor mounted in the main electricity power supply line, a voltage regulator for regulating the voltage delivered by the main generator, and an engine electricity network for delivering electricity to various loads situated in the zone of an engine fitted to the aircraft, and to a computer for controlling the engine, in which system the engine electricity network has a first power supply input connected to the main electricity power supply line via a secondary electricity power supply line, upstream from the line contactor, to receive electricity directly taken from the main generator, without passing via the electricity network on board the aircraft.

The system of the invention is remarkable in that the main generator is used directly as a transient electricity source for the electrical loads in the engine zone, i.e. as a source of electricity for powering electrical loads during the periods when they are activated. This avoids any need to cause electricity to transit between the fuselage zone and the engine zone, with the drawbacks that result therefrom in terms of weight and in-line losses. In addition, power line disturbances associated with the electromechanical technology of the power contactors in the primary network on board the aircraft are avoided.

Advantageously, the regulator of the voltage delivered by the main generator is situated in the engine zone and is powered by the engine electricity network. The same electricity sources can thus be used for powering the electrical loads in the engine zone, the engine control computer, and the voltage regulator. The voltage regulator may be integrated in the engine control computer (FADEC).

In an embodiment, the voltage regulator receives information representative of the voltage U_{ref} at a point of regulation situated on the main power supply line in the engine zone upstream from the line contactor, and of the line current I_{L} on the main power supply line downstream from the connection with the secondary power supply line, and it controls the main generator in such a manner as to maintain the voltage U_{ref} such that U_{ref}≈U₀+Z_{L}.I_{L}, where Z_{L} is the line impedance of the main power supply line between the regulation point and the input of the airplane electricity network, and U₀ is the AC voltage desired at the input of the electricity network of the aircraft. The term desired voltage U₀ means a determined voltage or a voltage having a value that lies within a determined range.

Also advantageously, the line contactor is controlled by the voltage regulator. For this purpose, the voltage regulator may receive information representative of the line current I_{L} at the input of the electricity network on board the aircraft, about the secondary current I_{sec} on the secondary electrical power supply line, and about the current I_{L} at the output from the main generator, to cause the line contactor to open when I_{φ}−(I_{L}+I_{sec})≧ΔI, where ΔI is a differential protection threshold.

In addition, the voltage regulator may be arranged to cause the line contactor to close, after the engine has started, once the voltage delivered by the main generator reaches a predetermined threshold.

Advantageously, the voltage regulator is connected to a protection circuit for protecting the network on board the aircraft to cause the line contactor to open in response of a signal received.

Also advantageously, the engine electricity network has a second input connected to the output of an auxiliary generator to receive an auxiliary voltage delivered by the auxiliary generator.

Preferably, the auxiliary generator and the main generator are integrated in a starter/generator. Thus, compared with the prior art architecture for the electricity power supply system, in this configuration a single auxiliary generator is used both as an auxiliary electricity source for the engine control computer and for the regulator of the voltage delivered by the main generator, thus avoiding recourse to a specific generator for the engine control computer. This mutualization of auxiliary electricity resources makes it possible not only to save on a specific generator, but also to save on a shaft line for driving such a generator in the transmission gearbox.

According to a particular feature of the electricity power supply system, the engine electricity network includes at least one bus for distributing electricity to loads situated in the engine zone, and an electricity power supply circuit connected to the first and second inputs of the engine electricity network and having an output connected to the electricity distribution bus to supply it with electricity derived from the main generator or from the auxiliary generator.

The electricity power supply circuit may have a third input connected to the network on board the aircraft to receive a voltage available thereon, so as to be able to power the engine electricity network, in particular before the engine has been started.

### BRIEF DESCRIPTION OF THE DRAWINGS

The invention can be better understood on reading the following description given by way of non-limiting indication and with reference to the accompanying drawings, in which:

FIG. 1, described above, is a very diagrammatic representation of a known electrical power supply system for an airplane and an engine fitted to the airplane;

FIG. 2 is a very diagrammatic view of the electrical power supply system of the invention for an aircraft and an engine fitted to the aircraft;

FIG. 3 is a more detailed view of a voltage regulator of the FIG. 2 power supply system; and

FIG. 4 is a more detailed view of a power supply circuit of an engine electrical network of the FIG. 2 system.

### DETAILED DESCRIPTION OF AN EMBODIMENT OF THE INVENTION

In the description below, the invention is applied to an airplane fitted with gas turbine engines. Nevertheless, the invention is applicable to airplanes fitted with engines of other types, and also to helicopters.

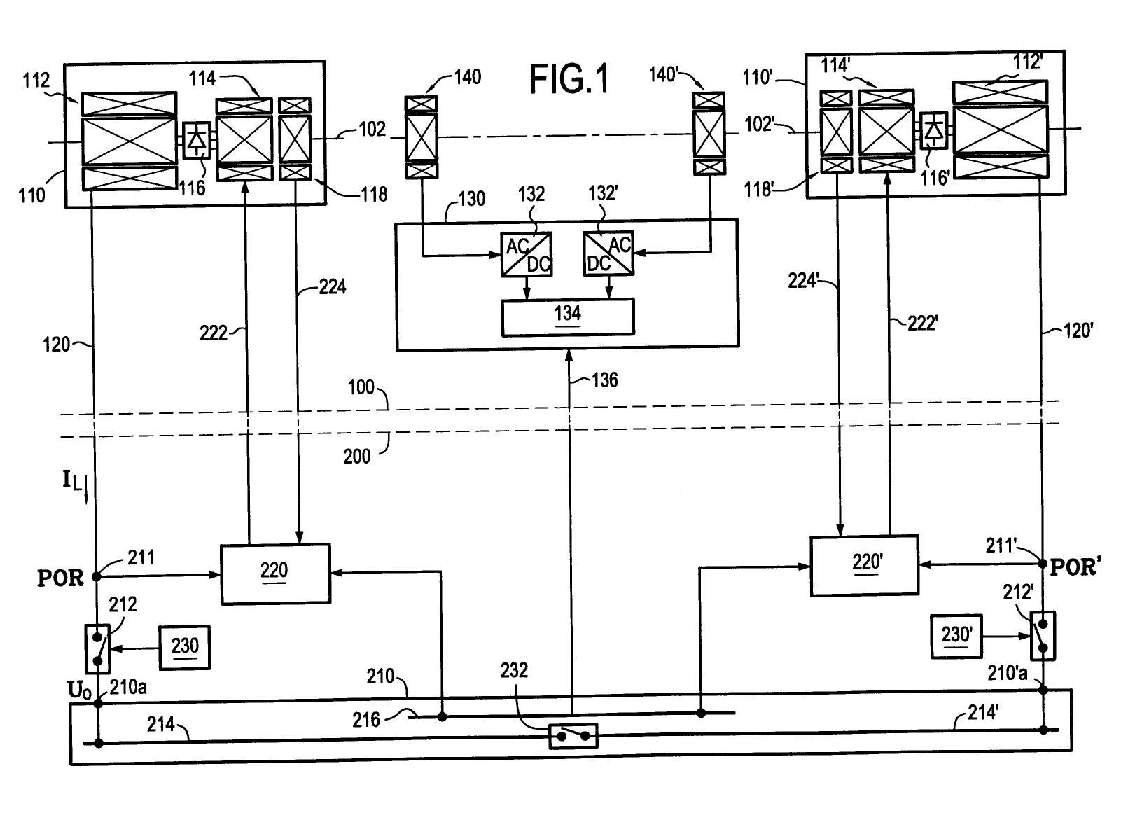

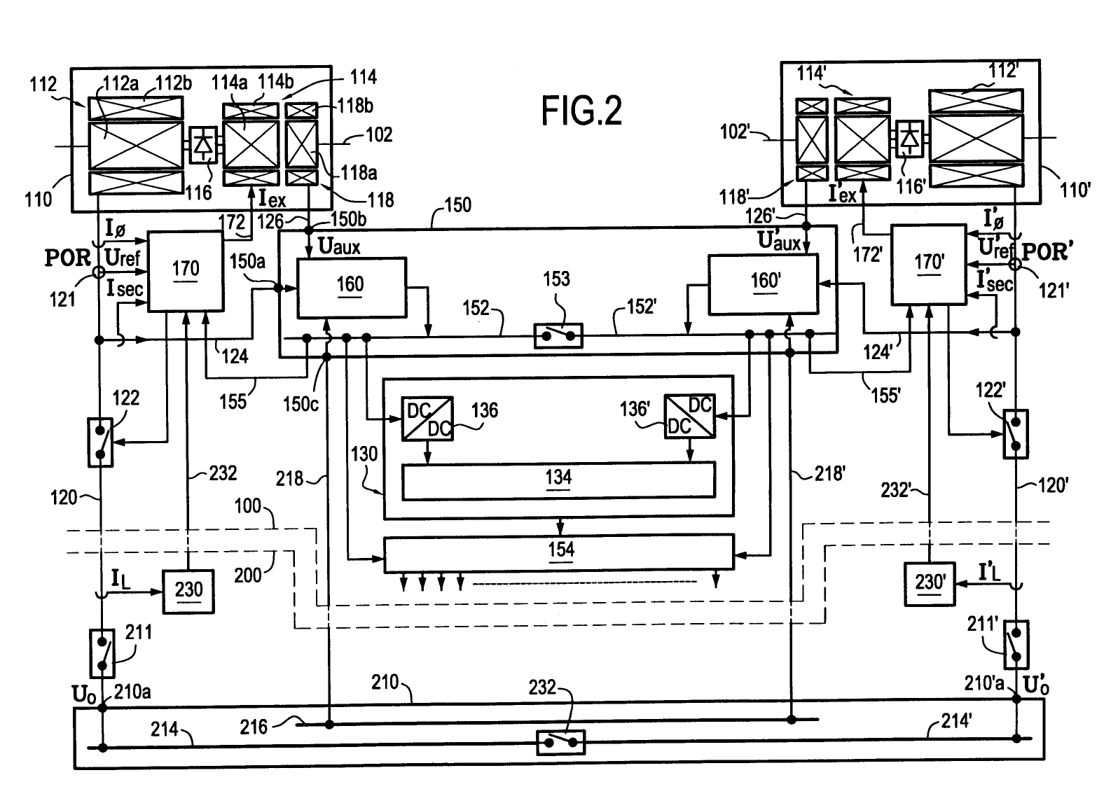

Elements in common between the architectures of the electrical power supply systems of FIGS. 1 and 2 have the same reference numerals.

Thus, in FIG. 2, as in FIG. 1, dashed lines 100 and 200 represent respectively the frontier of the engine zone and the frontier of the fuselage zone.

In the engine zone, a main electrical generator 112 here formed by a synchronous generator, is mechanically coupled to the engine by mounting the rotor (primary magnetic circuit) 112a of the generator on a shaft 102 connected to an accessory gearbox mounted on a mechanical power takeoff coupled to a turbine shaft of the engine. The rotor 112a of the main generator 112 is fed with DC by being electrically connected to the rotor (secondary magnetic circuit) 114a of an exciter 114 via a rotary diode bridge 116. The main generator 112 and the exciter 114 here together form a starter/generator 110 that further comprises an auxiliary generator 118 such as a permanent magnet generator. The rotor (primary magnetic circuit) 118a of the generator carrying the permanent magnet is mounted on the shaft 102 that is common to the rotors 112 and 114a.

The generator 112 constitutes a main source of electrical power that supplies an alternating voltage to the stator (secondary magnetic circuit) 112b in a main electricity power supply line or harness 120 that conveys this voltage to the input 210a of an on-board electricity network 210 of the airplane situated in its fuselage zone. A line contactor 122 is inserted on the main line 120 in the engine zone. A circuit breaker 211 is inserted in the main line 120 in the fuselage zone, immediately upstream from the input 210a.

The generator 118 constitutes an auxiliary electrical power source that supplies an auxiliary voltage to the stator (secondary magnetic circuit) 118b in an auxiliary electricity power supply line 126.

An electricity power supply and distribution network 150 in the engine zone, or engine electrical network, comprises an electricity distribution bus 152, e.g. a DC bus, and an electricity power supply circuit 160. The engine electricity network 150 has a first input 150a that is connected to the main power supply line 120 via a secondary electricity power supply line 124. The secondary line 124 is connected to the main line 120 upstream from the line contactor 122, i.e. between the contactor and the stator (secondary magnetic circuit) of the main generator. A second input 150b of the engine electricity network is connected to the auxiliary power supply line 126. A third input 150c of the engine electricity network is connected via a power supply line or harness 218 to an electricity bus of the network 210 on board the airplane, e.g. a DC bus 216.

The bus 152 supplies the electricity needed for operating an engine control computer or FADEC 130. The DC of the bus 152 is converted by a DC/DC converter 136 so as to power the components 134 of the FADEC.

The bus 152 also supplies the electricity needed for operating electrical loads in the engine zone. For this purpose, the bus 152 powers an electrical load management circuit 154 in the engine zone so as to power and control electrical loads in response to control signals delivered by the FADEC 130. In particular the electrical loads concerned may be: actuators for variable-geometry portions of the gas turbine engine such as compressor discharge valves, members for setting the pitch of variable-pitch stator vanes in the stator stages of the compressor, compressor transient discharge valves, or members for varying the gaps at the tips of the rotor blades of the turbine; members of the fuel feed circuit such as feed pump motors, air/lubricant separator devices, or recovery pump motors; and electrical loads in the pod region such as electromechanical actuators for thrust reversers or actuators for inspection or maintenance hatches.

The electrical load management circuit 154 lies outside the ambit of the present invention and may be implemented in accordance with the teaching of the present Applicant's application EP 1852347.

It should be observed that certain electrical loads in the engine surroundings, such as devices for deicing the pod or the edges of the wing, may be powered directly from the AC available on the secondary power supply line 124, under the control of the FADEC 130.

The bus 152 also supplies the electricity needed for operating a voltage-regulator circuit 170 that regulates the voltage supplied by the main generator 112, the regulator circuit 170 being situated in the engine zone. The regulator circuit feeds the stator (primary magnetic circuit) 114b of the exciter 114 via a line 172. When the starter/generator 110 is operating in motor mode (starting), the regulator circuit 170 delivers AC to the stator 114b, whereas when it is operating in generator mode, the regulator circuit 170 delivers DC to the stator 114b that is controlled so as to regulate the AC produced by the main generator 112.

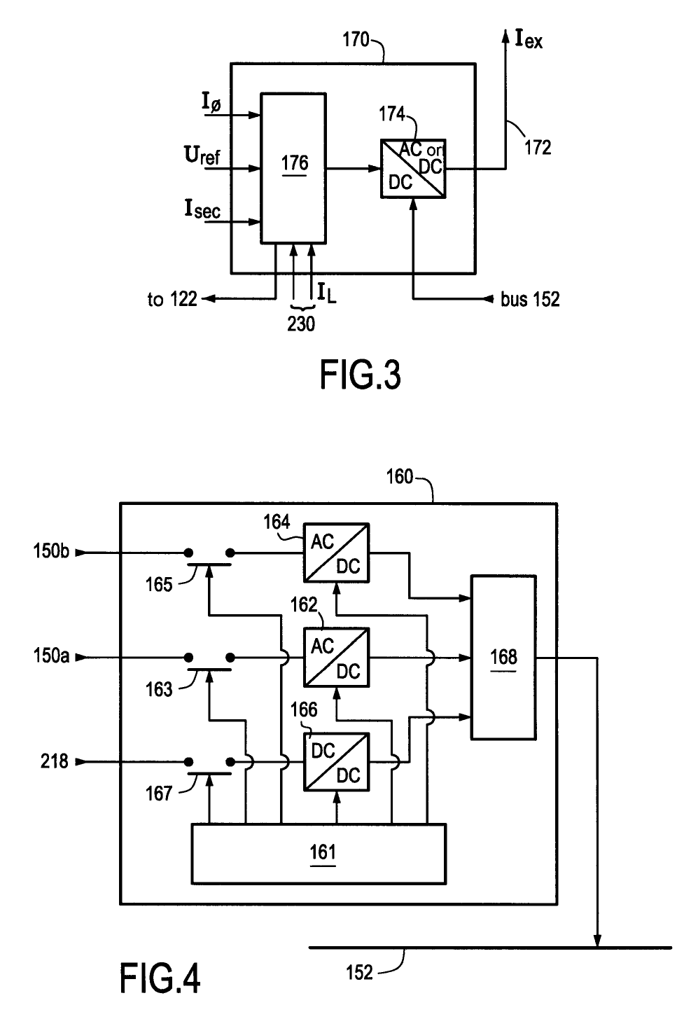

The structure and the operation of the regulator circuit 170 are described below in greater detail, with reference also to FIG. 3.

The regulator circuit 170 comprises a control module 176 and a converter 174 having its input connected to the bus 152 and its output connected to the line 172.

Via a voltage-measuring sensor, the control module 176 receives information representative of the voltage U_{ref} at a point of regulation POR 121 situated in the engine zone on the line 120 upstream from the line contactor 122. The control module 176 also receives information representative of the line current I_{L} at the input to the electricity network 210 on board the airplane. This information is delivered by a current-measuring sensor to a circuit 130 for monitoring and protecting the electrical network on board the airplane, and is conveyed from the circuit 130 to the voltage regulator 170, e.g. via a data bus 232. The control module also receives information delivered by a current measurement sensor that is representative of the current I_{φ} output by the main generator 112 (phase-neutral current at the stator 112b), and information delivered by a current sensor and representative of the current I_{sec} on the secondary electrical power supply line 124. Other information may be conveyed to the control module 176 from the circuit 230, in particular protection signals, an order to start the engine, or information concerning the surroundings (speed, . . . ).

The control module 176 delivers a control signal for the converter 174 to feed the stator 114b of the exciter 114 with exciter current Iₑₓ, and a signal for causing the line contactor 122 to open or close. The operation of the voltage regulator 170 is as follows.

To set the airplane engine into rotation for starting purposes, the line contactor 122 is closed. The converter 174 is operated in DC/AC converter mode by the control module 176 to deliver AC Iₑₓ to the stator (primary magnetic circuit) 114b of the exciter, while AC is delivered to the stator 112b of the main generator from the network 210 on board the airplane, the on-board network being powered via a starting converter by an external source or an auxiliary power unit (APU), or from another engine or the airplane. The starter/generator 110 then operates in synchronous motor mode (starter mode). When the speed of rotation of the shaft 102 (or of a turbine shaft of the airplane engine) reaches a first threshold, with the airplane engine combustion chamber being fed with fuel and with air, ignition of the airplane engine is controlled by the FADEC 130 powering an ignition spark plug in the combustion chamber. Once ignition has been achieved, the line contactor 122 is opened under the control of the voltage regulator 170. The speed of rotation of the shaft 102 increases so the frequency of the voltage delivered by the main generator 112 which is then operating in synchronous generator mode also increases. When the voltage U_{ref} and the frequency of the point POR 121 reach given voltage and frequency thresholds, the control module 176 of the voltage regulator 170 causes the line contactor 122 to close, insofar as exceeding a differential protection threshold (see below) has not been detected and a fault has not been detected by the circuit 230, which would lead to a protection signal being delivered to the control circuit 176. The voltage and frequency thresholds are selected in such a manner as to ensure that the voltage U₀ and the frequency on the line 120 at the input to the network on board the airplane are not less than the minimum voltage and frequency values that can be accepted by the network.

Operation during the airplane engine starting stage is entirely similar to that of a starter/generator in a known architecture for an airplane electrical power supply system such as that shown in FIG. 1, except that the voltage regulator 170 and the line contactor 122 are both situated in the engine zone. Another important difference compared with the known architecture lies in the fact that after engine ignition and before closing the line contactor 122, a voltage is available on the secondary power supply line 124 for feeding the engine electricity network, and thus for feeding loads situated in the engine zone.

In generator mode, the converter 174 is controlled in DC/DC converter mode by the control module 176 to deliver DC current Iₑₓ to the stator (primary magnetic circuit) 114b of the exciter. The current Iₑₓ is adjusted under the control of the control module 176 so that the voltage U_{ref} satisfies the formula U_{ref}≈U₀+Z_{L}.I_{L} where U₀ is the voltage desired on the power supply line 120 at the input 210a of the network on board the airplane, and Z_{L} is the line impedance between the input 210a and the point POR 121. It should be observed that this impedance Z_{L} varies as a function of the frequency f of the voltage delivered by the main generator 112. The function representing variation in the impedance Z_{L} is stored in the control module 176. The desired value U₀ is a value situated in a range going from a minimum threshold U₀ₘᵢₙ to a maximum threshold U₀ₘₐₓ, which thresholds are acceptable by the network 210 on board the airplane.

The voltage regulator 170 also performs a protection function. Thus, the line contactor is caused to open by the control module 176 when I_{φ}−(I_{L}+I_{sec})≧ΔI, where ΔI is a predetermined differential protection threshold, indicating that the current leakage threshold on the power supply line 120 has been exceeded. The control module 176 can also receive an order from the protection circuit 130 to open the line contactor 122 when a fault, such as a surge, is detected on the network 210 on board the airplane, e.g. on the AC bus 214. For additional security, an additional line contactor directly under the control of the protection circuit 230 could be inserted in the main power supply line 120 in the fuselage zone, at the input to the network 210 on board the airplane, instead of and replacing the circuit breaker 211.

The voltage regulator 170 may be integrated in the FADEC 130, with the functions of the control module 176 then being provided by the logical resources internal to the FADEC 130.

The structure and the operation of the electricity power supply circuit 160 are described below in detail also with reference to FIG. 4.

The power supply circuit 160 comprises a first AC/DC converter 162 having its input connected to the input 150a of the engine electricity network via a contactor 163 to receive the AC available on the secondary electricity power supply line 124. The output from the AC/DC converter 162 is connected to the DC bus 152 via a DC bus circuit 168, e.g. of the HVDC type that feeds the DC bus 152. A secondary AC/AC converter 164 has its input connected to the input 150b of the engine electricity network via a contactor 165 to receive the AC available on the auxiliary electrical power supply line 126. The output from the AC/DC converter 164 is connected to the bus circuit 168. A DC/DC converter 166 has its input connected to the input 150c of the engine electricity network via a contactor 167 for receiving the DC delivered by the line 218, and has its output connected to the bus circuit 168.

The power supply circuit 160 has a control module 161 that controls the contactors 163, 165, 167 and that controls the converters 162, 164, 166 to supply the DC bus 152 with a DC voltage of predetermined amplitude.

The contactor 167 is controlled to take on an open state, i.e. it is normally-closed to feed the engine electricity network 150 before the airplane engine has started, while the contactors 163 and 165 which can be controlled to take on the closed state, are then open. It should be observed that an external power supply line other than the DC bus 216 of the network 210 on board the airplane could be used.

The control module 161 receives information from the voltage regulator 170, or directly from a voltage sensor, that is representative of the voltage U_{ref} available on the secondary power supply line 124 after the airplane engine has started and the line contactor 122 has opened. When the voltage U_{ref} reaches a predetermined threshold U_{refmin} that is considered as being sufficient for powering the engine electricity network, the control module 161 causes the contactor 165 to close and the contactor 167 to open, which module also controls the AC/DC converter 162 to maintain the desired DC voltage on the DC bus 152. As mentioned above, it should be observed that the engine electricity network 150 is fed with the voltage delivered by the main generator, advantageously starting from the moment when the voltage U_{ref} reaches a threshold below that from which the line contactor 122 is closed.

The control module 161 also receives from a voltage-measuring sensor information representative of the amplitude of the voltage Uₐᵤₓ delivered by the auxiliary generator 118 on the auxiliary power supply line 126. If the voltage U_{ref} drops below the minimum threshold U_{refmin}, the control module 161 causes the contactor 165 to close so as to enable the engine electricity network to be powered by the secondary power supply line 126, the contactor 163 being released to take on the open state. The AC/DC converter 164 is controlled by the control module 161 to maintain the desired voltage on the DC bus 152. If the voltage Uₐᵤₓ becomes insufficient, in the event of a breakdown, the contactor 163 is released to take on the open state and the contactor 167 is released to take on the closed state so that electricity can continue to be fed to the engine electricity network 150 from the electricity network 210 on board the airplane.

It should be observed that the control module 161 may be integrated in the FADEC 130.

As shown in FIG. 2, the components of the electricity power supply system as described above are duplicated for redundancy purposes.

Thus, a second main generator 112′ and its exciter 114, interconnected by a rotary diode bridge 116, have their rotors coupled to a shaft 102′ rotated by a connection with the airplane engine transmission gearbox, together with the rotor of an auxiliary generator 118′, the assembly 112′, 114′, 116′, and 118′ forming a starter/generator 110′ similar to the starter/generator 110.

A main power supply line 120′ on which a line contactor 122′ is interposed in the engine zone delivers the voltage produced by the main generator 112′ to an input 210′a of the electricity network on board the airplane via a circuit breaker 211′ situated in the fuselage zone in order to power the AC bus 214′ of said network.

The engine electricity network 150 has a second DC bus 152′ and a second secure power supply circuit 160′ analogous to the circuit 160. The circuit 160′ receives a voltage delivered by the main generator 112′ via a secondary power supply line 124′ that is connected to the main power supply line 120′ upstream from the line contactor 122′, together with a voltage delivered by the auxiliary generator 118′ via an auxiliary power supply line 126′. The bus 152′ delivers DC to a DC/DC converter 136′ powering the FADEC 130, with this being implemented in known manner with redundancy using two identical portions that are powered by the buses 152 and 152′.

Similarly, the circuit 154 for managing electrical loads in the engine zone is powered in parallel by the buses 152 and 152′.

A line contactor 153 is inserted between the buses 152 and 152′. The contactor 153 is normally open. It is caused to close in the event of a breakdown when the voltage on one of the buses 152 and 152′ becomes insufficient.

A second voltage regulator 170′ analogous to the regulator 170 and powered by the bus 152′ regulates the voltage at a point of regulation POR 121′ situated in the engine zone on the main power supply line 120′ upstream from the contactor 122′. The voltage regulator 170′ also situated in the engine zone receives information representative of the voltage U′_{ref} at the point POR 121′, together with information relayed over a data bus 232′ by a monitoring and protection circuit 230′ in the fuselage zone and representative of the line current I′_{L}, and it controls the current I′ₑₓ delivered to the exciter 114′. The voltage regulator 170′ controls the line contactor 122′ and also receives information representative of the current I′_{sec} on the secondary power supply line 126′ and of the phase/neutral current I′_{φ} at the output from the main generator 112′ to provide a differential protection function. The voltage regulator 170′ may also receive from the monitoring and protection circuit 230′: protection information; a starting order; and information about the surrounding, for the purpose of causing the line contactor 122′ to open in the event of a fault being detected in the electricity network 210 on board the airplane, or on starting.

In the network 210, a contactor 232 is interposed between the AC buses 214, 214′, the contactor 232 being closed in the event of a failure of one of the main generators 112, 112′, the failing generator then being isolated from the buses 214, 214′ by opening the associated line contactor 122 or 122′.

What is claimed is:

1. An electricity power supply system for an aircraft, the system comprising:
at least one main generator for delivering AC, an electricity network on board the aircraft, a main electricity power supply connecting the main generator to the electricity network on board the aircraft to power the electricity network on board the aircraft to feed it with AC delivered by the main generator, at least one line contactor mounted in the main electricity power supply line, a voltage regulator for regulating the voltage delivered by the main generator, and an engine electricity network for delivering electricity to various loads situated in the zone of an engine fitted to the aircraft, and to a computer for controlling the engine,
wherein the engine electricity network has a first power supply input connected to the main electricity power supply line via a secondary electricity power supply line, upstream from the line contactor, to receive electricity directly taken from the main generator, without passing via the electricity network on board the aircraft.

2. A system according to claim 1, wherein the voltage regulator regulating the voltage delivered by the main generator is situated in the engine zone and is powered by the engine electricity network.

3. A system according to claim 2, wherein the voltage regulator is integrated in the engine control computer.

4. A system according to claim 2, wherein the voltage regulator receives information representative of the voltage U_{ref} at a point of regulation situated on the main power supply line in the engine zone upstream from the line contactor, and of the line current I_{L} on the main power supply line downstream from the connection with the secondary power supply line, and it controls the main generator in such a manner as to maintain the voltage U_{ref} such that U_{ref}≈U₀+Z_{L}.I_{L}, where Z_{L} is the line impedance of the main power supply line between the regulation point and the input of the airplane electricity network, and U₀ is the AC voltage desired at the input of the electricity network of the aircraft.

5. A system according to claim 2, wherein the line contactor is controlled by the voltage regulator.

6. A system according to claim 5, wherein the voltage regulator receives information representative of the line current I_{L} at the input of the electricity network on board the aircraft, about the secondary current I_{sec} on the secondary electrical power supply line, and about the current I_{φ} at the output from the main generator, to cause the line contactor to open when I_{φ}−(I_{L}+I_{sec})≧ΔI, where ΔI is a differential protection threshold.

7. A system according to claim 5, wherein the voltage regulator is arranged to cause the line contactor to close, after the engine has started, when the voltage delivered by the main generator reaches a predetermined thresholds.

8. A system according to claim 5, wherein the voltage regulator is connected to a protection circuit for protecting the network on board the aircraft to cause the line contactor to open in response of a signal received.

9. A system according to claim 1, wherein the engine electricity network has a second input connected to the output of an auxiliary generator to receive an auxiliary voltage delivered by the auxiliary generator.

10. A system according to claim 9, wherein the auxiliary generator and the main generator are integrated in a starter/generator.

11. A system according to claim 9, wherein the engine electricity network includes at least one bus for distributing electricity to loads situated in the engine zone, and an electricity power supply circuit connected to the first and second inputs of the engine electricity network and having an output connected to the electricity distribution bus to supply it with electricity derived from the main generator or from the auxiliary generator.

12. A system according to claim 11, wherein the electricity power supply circuit has a third input connected to the network on board the aircraft to receive a voltage available thereon.
